(19) United States
(12) Patent Application Publication
(10) Pub. No.: US 2026/0365305 A1
(43) Pub. Date: Nov. 19, 2026

(54) SYSTEM AND METHOD FOR RESTRAINING A GALLEY CART WITHIN AN INTERNAL CABIN OF AN AIRCRAFT

(71) Applicant: THE BOEING COMPANY, Arlington, VA (US)

(72) Inventors: Paul Addis, Bothell, WA (US); Justin Tabora, Bothell, WA (US); Timothy D. Rittenhouse, JR., Summerville, SC (US); Karl N. Straube, Seattle, WA (US); Benjamin Palmer, Mountlake Terrace, WA (US); William Noble, Edmonds, WA (US); Robert Blosser, Snohomish, WA (US); Christofer Pederson

(73) Assignee: THE BOEING COMPANY, (omitted)

(21) Appl. No.: 19/751,449

(22) Filed: Jul. 23, 2026

Related U.S. Application Data
(63) Continuation-in-part of application No. 19/656,459, filed on Apr. 23, 2026.
Application No. 19/656,459 is a continuation-in-part of application No. 18/809,417, filed on Aug. 20, 2024, now Pat. No. 12,643,660.

(51) Int. Cl. B64D 11/00

(52) U.S. Cl. CPC B64D 11/0007

(57) ABSTRACT

A system for restraining a galley cart within an internal cabin of a vehicle includes a mounting frame configured to be secured to a wall within the internal cabin. A shelf is pivotally coupled to the mounting frame. The shelf is configured to be moved between a first stowed position against one or both of the wall or the mounting frame, and a first deployed position that is configured to allow items to be supported on the shelf. The shelf includes a release handle configured to be engaged to unlock the shelf from the first deployed position.

### CROSS-REFERENCE TO RELATED APPLICATIONS

This application is a continuation-in-part of U.S. Patent Application No. 19/656,459, filed Apr. 23, 2026, which, in turn, in a continuation-in-part of U.S. Patent Application No. 18/809,417, filed Aug. 20, 2024, now U.S. Patent No. 12,643,660, each of which is hereby incorporated by reference in its entirety.

### FIELD OF THE DISCLOSURE

Examples of the present disclosure generally relate to a system and a method for restraining a galley cart within an internal cabin of an aircraft, such as a commercial aircraft.

### BACKGROUND OF THE DISCLOSURE

Vehicles such as commercial aircraft are used to transport passengers between various locations. A typical aircraft includes an internal cabin having seats for passengers, one or more galleys, and one or more lavatories.

A galley within an internal cabin of a commercial aircraft includes cart compartments for retaining galley carts. A cart compartment includes a dedicated housing having walls and an upper surface, such as a ledge or countertop. A galley cart can be moved into and out of the compartment.

During a flight, an attendant moves a galley cart (such as a trash cart) to and from locations within the internal cabin and the compartment within the galley. In certain situations, the attendant may determine that positioning the galley cart at a different location may be desirable, such as prior to, during, or after a trash collection process.

However, space is limited within an internal cabin of an aircraft. Further, various locations within an aircraft are unable to secure a galley cart in position.

### SUMMARY OF THE DISCLOSURE

A need exists for a system and a method for securing a galley cart in a convenient position within an internal cabin of an aircraft. Further, a need exists for a system and a method for securing a galley cart at a location other than a dedicated compartment within a galley.

With those needs in mind, certain examples of the present disclosure provide a system for restraining a galley cart within an internal cabin of a vehicle. The system includes a mounting frame configured to be secured to a wall within the internal cabin. A cart restrainer is moveably coupled to the mounting frame. The cart restrainer is configured to be moved between a first stowed position against one or both of the wall or the mounting frame, and a first deployed position that is configured to restrain the galley cart against one or both of the wall or the mounting frame.

In at least one example, the vehicle includes a monument that includes the wall. The monument can be a lavatory. The wall can face a cross-aisle within the internal cabin. A flight attendant seat can also be secured to the wall and/or a floor.

In at least one example, the cart restrainer includes a first arm connected to a second arm by a cross bar.

In at least one example, the mounting frame includes one or more restraining clips moveable between a restraining position, in which the restraining clips restrain the cart restrainer in the first stowed position, and a release position, in which the cart restrainer can be moved between the first stowed position and the first deployed position.

In at least one example, the system also includes a shelf moveably coupled to the mounting frame. The shelf is configured to be moved between a second stowed position against one or both of the wall or the mounting frame, and a second deployed position that is configured to allow items to be supported on the shelf. As a further example, the cart restrainer and the shelf are independently moveable.

In at least one example, the mounting frame includes one or more restraining clips moveable between a restraining position, in which the restraining clips restrain the shelf in the second stowed position, and a release position, in which the shelf can be moved between the second stowed position and the second deployed position.

The shelf can include one or more cart holding arms and/or one or more cart holding paddles.

In at least one example, lateral support arms are moveably coupled to the shelf and the mounting frame.

The mounting frame can include a cover shroud at a lower end, and/or a bumper.

Certain examples of the present disclosure provide a method including moving the cart restrainer between a first stowed position against one or both of the wall or the mounting frame, and a first deployed position that is configured to restrain the galley cart against one or both of the wall or the mounting frame. In at least one example, the method also includes moving the shelf between a second stowed position against one or both of the wall or the mounting frame, and a second deployed position that is configured to allow items to be supported on the shelf.

Certain examples of the present disclosure provide a vehicle, such as an aircraft, which includes a system for restraining a galley cart, as described herein.

Certain examples of the present disclosure provide a system for restraining a galley cart within an internal cabin of a vehicle. The system includes a mounting frame configured to be secured to a wall within the internal cabin. A shelf is pivotally coupled to the mounting frame. The shelf is configured to be moved between a first stowed position against one or both of the wall or the mounting frame, and a first deployed position that is configured to allow items to be supported on the shelf. The shelf includes a main body having a first surface, a first end, and a second end opposite from the first end. The second end is pivotally coupled to the mounting frame. One or more cart holding arms are pivotally coupled to the main body. The one or more cart holding arms are moveable between a second stowed position and a second deployed position.

In at least one example, the one or more cart holding arms are pivotally coupled to the first surface at the first end.

In at least one example, the shelf further includes one or more holding paddles pivotally coupled to the main body. The one or more holding paddles are moveable between a third stowed position and a third deployed position. A top portion of galley cart is configured to be restrained between the one or more cart holding arms in the second deployed position and the one or more holding paddles in the third deployed position when the shelf is in the first deployed position.

In at least one example, the one or more cart holding arms include one or more front cart holding arms, and one or more lateral cart holding arms. As a further example, the one or more front cart holding arms include a first front cart holding arm and a second cart holding arm, and the one or more lateral cart holding arms include a first lateral cart holding arm and a second lateral cart holding arm. The galley cart is configured to be restrained between the first front cart holding arm, the second front cart holding arm, the first lateral cart holding arm, and the second lateral cart holding arm.

In at least one example, the system also includes lateral support arms which couple the shelf to the mounting frame. The galley cart is configured to be restrained between the one or more cart holding arms and the lateral support arms in extended support positions. As a further example, mounting frame includes lateral uprights. The second end of the shelf is pivotally coupled to upper portions of the lateral uprights.

In at least one example, the shelf also includes a release latch. For example, the release latch is disposed at a central portion of the second end of the shelf. The release latch can include a button moveably retained within a reciprocal opening formed in the second end of the shelf. As a further example, the button is operatively coupled to one or more bracing rods configured to engage the mounting frame.

Certain examples of the present disclosure provide a system for restraining a galley cart within an internal cabin of a vehicle. The system includes a mounting frame configured to be secured to a wall within the internal cabin. A shelf is pivotally coupled to the mounting frame. The shelf is configured to be moved between a first stowed position against one or both of the wall or the mounting frame, and a first deployed position that is configured to allow items to be supported on the shelf. The shelf includes a release handle configured to be engaged to unlock the shelf from the first deployed position.

In at least one example, the shelf further includes a recessed area. The release handle is moveably secured within the recessed area. As a further example, the recessed area is defined between an upper recessed wall of a central front portion of the shelf, lateral walls formed in the shelf, and a rear wall formed in the shelf. As a further example, the shelf also includes a central block forwardly extending from the rear wall.

In at least one example, the shelf also includes cart holding arms pivotally coupled to the rear wall. The central block is disposed between the cart holding arms. The cart holding arms are moveable between a second stowed position and a second deployed position,.

In at least one example, the shelf also includes holding paddles moveably coupled to the cart holding arms through one or more links. The holding paddles are moveable between a third stowed position and a third deployed position. A top portion of the galley cart is configured to be restrained between the cart holding arms in the second deployed position and the holding paddles in the third deployed position when the shelf is in the first deployed position. In at least one example, the one or more links comprise one or more rods. Each of the cart holding arms is coupled to a respective one of the cart holding arms by the one or more rods.

In at least one example the release handle includes a grasp bar having a bowed indented channel.

In at least one example, the release handle connects to a beam which extends into an internal chamber of the shelf. The beam connects to a coupling cross beam within the central chamber. The coupling cross beam connects to rods connected to latches. As a further example, the beam extends into and through an opening formed in the central block within the recessed area of the shelf. As a further example, the coupling cross beam includes a central bracket. Lateral arms extend from the bracket and connect to pivot brackets. The pivot brackets connect to the rods.

In at least one example, the mounting frame includes retaining recesses which retain one or more portions of the latches when the shelf is in the first deployed position.

In at least one example, the shelf also includes one or more stops configured to limit a range of motion of the release handle.

### BRIEF DESCRIPTION OF THE DRAWINGS

FIG. 1 illustrates a perspective front view of an aircraft, according to an example of the present disclosure.

FIG. 2 illustrates a perspective interior view of an internal cabin of an aircraft, according to an example of the present disclosure.

FIG. 3 illustrates a perspective view of a system for restraining a galley cart within an internal cabin of an aircraft, according to an example of the present disclosure.

FIG. 4 illustrates a perspective view of the system in a stowed position, according to an example of the present disclosure.

FIG. 5 illustrates a front view of the system in the stowed position.

FIG. 6 illustrates a perspective view of the system restraining a galley cart within the internal cabin, according to an example of the present disclosure.

FIG. 7 illustrates a perspective front view of the system having a shelf in a deployed position, according to an example of the present disclosure.

FIG. 8 illustrates a perspective side view of the shelf in the deployed position, according to an example of the present disclosure.

FIG. 9 illustrates a top plan view of a portion of an internal cabin, according to an example of the present disclosure.

FIG. 10 illustrates an isometric internal view of a lavatory, according to an example of the present disclosure.

FIG. 11 illustrates a perspective view of a system restraining a galley cart within an internal cabin of an aircraft, according to an example of the present disclosure.

FIG. 12 illustrates a perspective view of a system for restraining a galley cart within an internal cabin of an aircraft, according to an example of the present disclosure.

FIG. 13 illustrates a perspective view of the system of FIG. 12 in a deployed position, according to an example of the present disclosure.

FIG. 14A illustrates a perspective front view of the system of FIGS. 12 and 13 restraining a galley cart within an internal cabin of an aircraft.

FIG. 14B illustrates a front view of the system of FIGS. 12 and 13 restraining the galley cart within the internal cabin of the aircraft.

FIG. 14C illustrates a perspective side of the system of FIGS. 12 and 13 restraining the galley cart within the internal cabin of the aircraft.

FIG. 15 illustrates a perspective top view of the system of FIGS. 12-14 in the deployed position.

FIG. 16 illustrates a perspective bottom view of the system of FIGS. 12-15 in the deployed position.

FIG. 17 illustrates a front, top perspective view of a rear end of a shelf of the system of FIGS. 12-16 in the deployed position.

FIG. 18 illustrates a rear, bottom perspective view of the rear end of the shelf of the system of FIGS. 12-17 in the deployed position.

FIG. 19 illustrates a perspective front view of a system in a stowed position, according to an example of the present disclosure.

FIG. 20 illustrates a perspective front view of the system of FIG. 19 in a deployed position.

FIG. 21 illustrates a front view of the system of FIGS. 19 and 20 restraining a galley cart within an internal cabin of an aircraft.

FIG. 22 illustrates a side perspective view of the system of FIGS. 19-21 restraining the galley cart within the internal cabin of the aircraft.

FIG. 23 illustrates a bottom perspective view of a shelf of the system of FIGS. 19-22.

FIG. 24 illustrates a cross-sectional view of the shelf of the system through line 24-24 of FIG. 20.

FIG. 25 illustrates a perspective cross-sectional view of a portion of the shelf of the system through line 24-24 of FIG. 20.

FIG. 26 illustrates a perspective internal lateral view of an end of the shelf in the deployed position, according to an example of the present disclosure.

FIG. 27 a perspective top view of the end of the shelf in the deployed position.

### DETAILED DESCRIPTION OF THE DISCLOSURE

The foregoing summary, as well as the following detailed description of certain embodiments will be better understood when read in conjunction with the appended drawings. As used herein, an element or step recited in the singular and preceded by the word "a" or "an" should be understood as not necessarily excluding the plural of the elements or steps. Further, references to "one embodiment" are not intended to be interpreted as excluding the existence of additional embodiments that also incorporate the recited features. Moreover, unless explicitly stated to the contrary, embodiments "comprising" or "having" an element or a plurality of elements having a particular condition can include additional elements not having that condition.

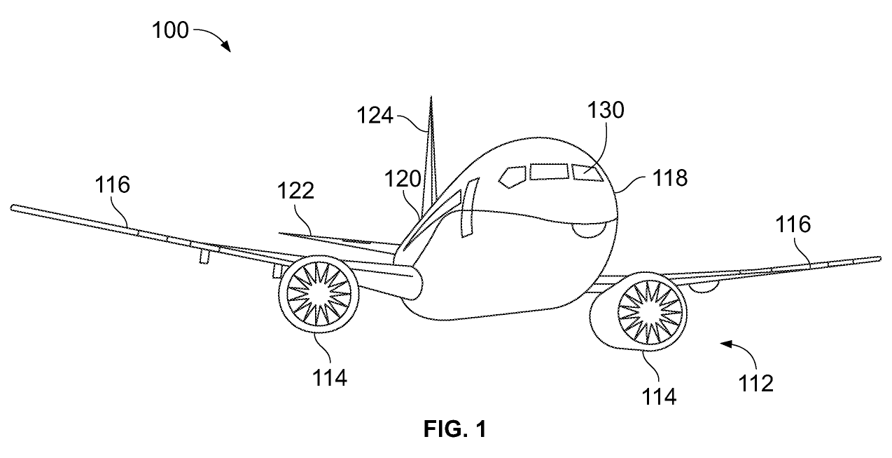

FIG. 1 illustrates a perspective front view of an aircraft 100, according to an example of the present disclosure. The aircraft 100 includes a propulsion system 112 that includes engines 114, for example. Optionally, the propulsion system 112 may include more engines 114 than shown. The engines 114 are carried by wings 116 of the aircraft 100. In other examples, the engines 114 may be carried by a fuselage 118 and/or an empennage 120. The empennage 120 may also support horizontal stabilizers 122 and a vertical stabilizer 124.

The fuselage 118 of the aircraft 100 defines an internal cabin 130, which includes a flight deck or cockpit, one or more work sections (for example, galleys, personnel carry-on baggage areas, and the like), one or more passenger sections (for example, first class, business class, and coach sections), one or more lavatories, and/or the like. As described herein, the aircraft 100 includes a system for restraining a galley cart within the internal cabin. The system differs from a cart compartment having a housing within a galley.

Alternatively, instead of an aircraft, the system and method as described herein can be used with various other vehicles, such as automobiles, buses, locomotives and train cars, watercraft, spacecraft, and the like.

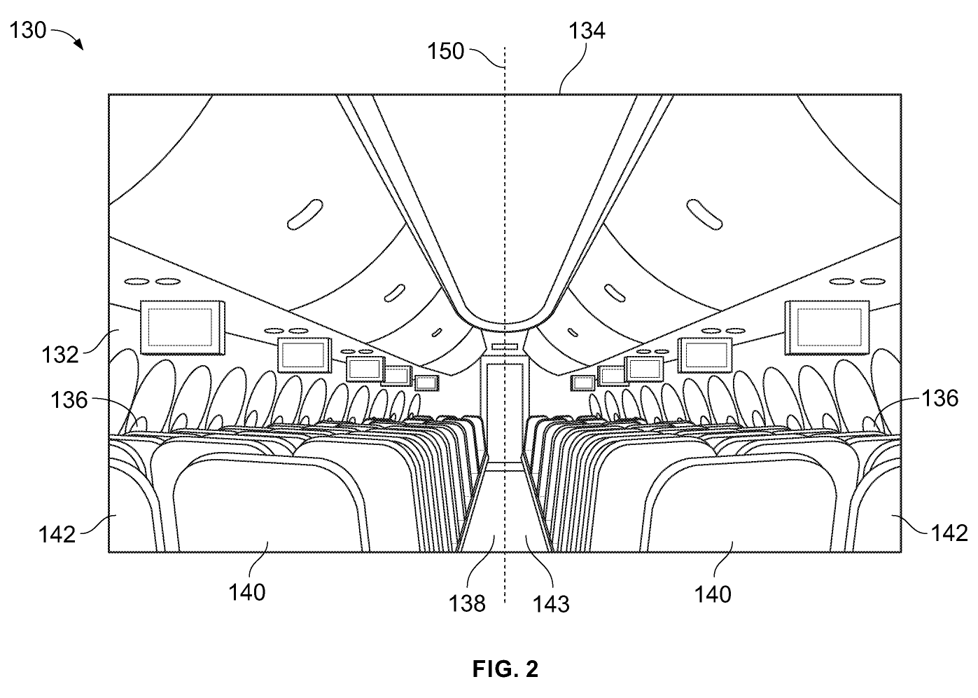

FIG. 2 illustrates a perspective interior view of an internal cabin 130 of an aircraft, according to an example of the present disclosure. The internal cabin 130 includes outboard walls 132 and a ceiling 134. Windows 136 are formed within the outboard walls 132. A floor 138 supports rows of seats 140. As shown in FIG. 2, a row 142 may include three seats 140 on either side of an aisle 143. However, the row 142 may include more or less seats 140 than shown. Additionally, the internal cabin 130 may include more aisles than shown.

As used herein, the term “outboard” means a position that is further away from a central longitudinal plane 150 of the internal cabin 130 as compared to another component. The term “inboard” means a position that is closer to the central longitudinal plane 150 of the internal cabin 130 as compared to another component.

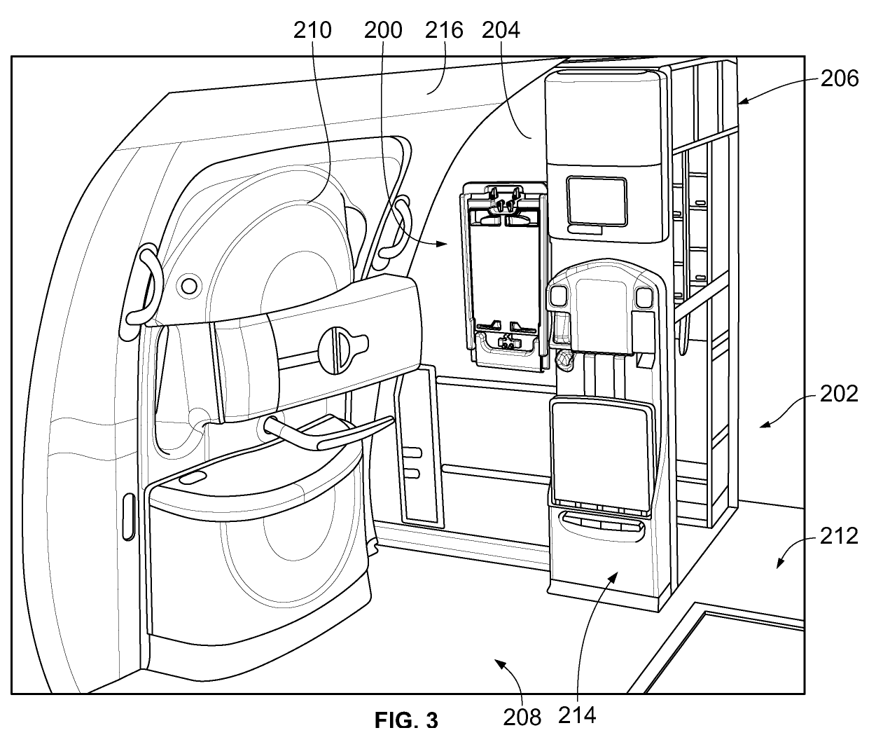

FIG. 3 illustrates a perspective view of a system 200 for restraining a galley cart within an internal cabin 202 of an aircraft, according to an example of the present disclosure. The internal cabin 202 is an example of the internal cabin 130 shown in FIGS. 1 and 2. The system 200 is secured to a wall 204 of a monument 206, such as a galley. As another example, the monument 206 is a lavatory. As another example, the monument 206 is a closet.

The wall 204 faces a cross-aisle 208, which can be an egress path that leads to an exit door 210 within the internal cabin 202. The cross-aisle 208 intersects an aisle 212, which can be parallel to a longitudinal plane (such as the central longitudinal plane 150 shown in FIG. 2) of the internal cabin 202. The system 200 can be outboard from the aisle 212. Optionally, the system 200 can be inboard from the aisle 212 (such as if the system 200 is between two aisles).

As shown, the system 200 is mounted to the wall 204, which also supports a flight attendant seat 214. That is, the flight attendant seat 214 is also secured to the wall 204 and/or a floor. The system 200 is disposed between an outer wall 216 and the flight attendant seat 214. The system 200 is outboard from the flight attendant seat 214. Optionally, the system 200 can be secured to other walls, which may not also support a flight attendant seat. As another example, the system 200 can be inboard from the flight attendant seat 214.

As shown in FIG. 3, the system 200 is shown in a stowed position. In the stowed position, the system 200 can be recessed into the wall 204. For example, the wall 204 can include a recessed channel that retains the system 200.

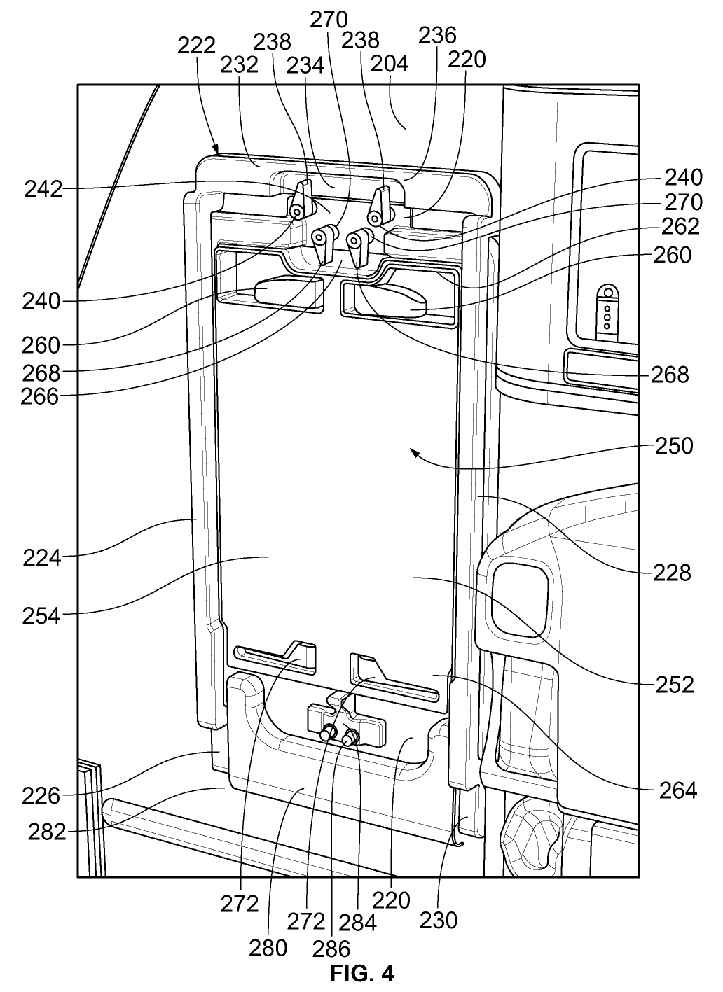

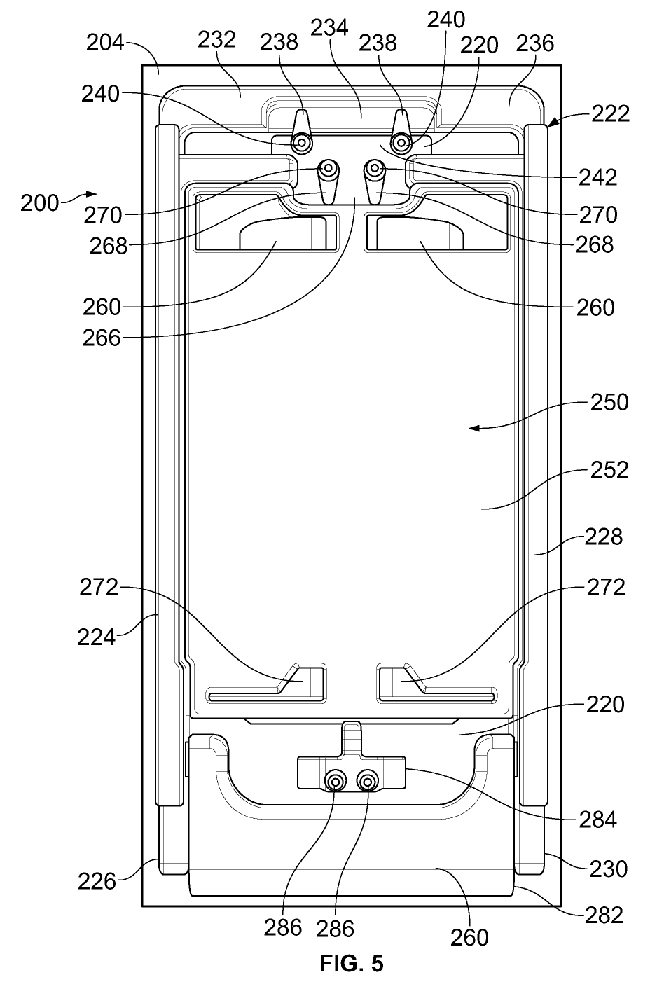

FIG. 4 illustrates a perspective view of the system 200 in the stowed position, according to an example of the present disclosure. FIG. 5 illustrates a front view of the system 200 in the stowed position. Referring to FIGS. 4 and 5, the system 200 includes a mounting frame 220 that is secured to the wall 204. For example, the mounting frame 220 is secured to the wall 204 through one or more fasteners, adhesives, and/or the like. A cart restrainer 222 is pivotally secured to the mounting frame 220. The cart restrainer 222 is configured to pivot between a stowed position (as shown in FIG. 4) and a deployed position. The cart restrainer 222 includes a first arm 224 pivotally coupled to the mounting frame 220 at a first root 226 (such as via a pivot pin), a second arm 228 pivotally coupled to the mounting frame 220 at a second root 230 (such as via a pivot pin), and a cross bar 232 connecting the first arm 224 and the second arm 228, and which is distally located from the first root 226 and the second root 230. The first arm 224 and the second arm 228 are spaced part from one another. The first arm 224 and the second arm 228 can be parallel to one another, and perpendicular to the cross bar 232. Optionally, one or more of the first arm 224, the second arm 228, and the cross bar 232 can be sized and shaped differently. For example, the first arm 224, the second arm 228, and the cross bar 232 can connect together in a curved, U, and/or horseshoe shape.

The cross bar 232 includes a channel 234 formed in a surface 236. The channel 234 is configured to receive holding ends 238 of restraining clips 240 pivotally secured to a top plate 242 of the mounting frame 220. The restraining clips 240 can be quarter turn clips that are moveable between a restraining position, as shown in FIG. 4, and a release position. In the restraining position, the holding ends 238 hold the cross bar 232, and therefore the cart restrainer 222, in the stowed position. The mounting frame 220 can include more or fewer restraining clips 240 than shown.

The system 200 also includes a shelf 250 pivotally secured to the mounting frame 220, such as via pivot pins. The shelf 250 is configured to move between a stowed position (as shown in FIG. 4) and a deployed position. The shelf 250 and the cart restrainer 222 are independently movable from one another. For example, the cart restrainer 222 can be in a deployed position, while the shelf 250 is in a stowed position. As another example, the cart restrainer 222 can be in the stowed position, while the shelf 250 is in the deployed position. As another example, both the cart restrainer 222 and the shelf 250 can be in stowed positions (as shown in FIG. 4). As another example, both the cart restrainer 222 and the shelf 250 can be in deployed positions.

The shelf 250 includes a planar main body 252 having a surface 254. In the stowed position, the surface 254 is a front surface. In the deployed position, the surface 254 is a bottom surface. The surface 254 is opposite from another surface (hidden from view in FIG. 4), which is parallel to (and can abut against) the wall 204 when the shelf 250 is in the stowed position. When the shelf 250 is in the deployed position, the other surface (opposite from the surface 254) is a top surface.

The shelf 250 includes cart holding arms 260 pivotally coupled to the surface 254 proximate to a first end 262, which is opposite from a second end 264 that pivotally couples to the mounting frame 220. The cart holding arms 260 are movable between a stowed position (as shown in FIG. 4), and a deployed position. The cart holding arms 260 can be quarter turn arms, for example.

The shelf 250 also includes a channel 266 formed in the surface 254 proximate to the top plate 242 of the mounting frame 220. The channel 266 is configured to receive holding ends 268 of restraining clips 270 pivotally secured to the top plate 242 of the mounting frame 220 below the restraining clips 240. The restraining clips 270 can be quarter turn clips that are moveable between a restraining position, as shown in FIG. 4, and a release position. In the restraining position, the holding ends 268 hold the shelf 250 in the stowed position. The mounting frame 220 can include more or fewer restraining clips 270 than shown.

The shelf 250 can also include holding paddles 272 pivotally coupled to the main body 252 proximate to the second end 264. The holding paddles 272 are moveable between stowed positions (as shown in FIG. 4) and deployed positions. A top portion of a galley cart can be restrained between the holding arms 260 in deployed positions and the holding paddles 272 in deployed positions when the shelf 250 is in the deployed position. The shelf 250 can include more or fewer holding arms 260 and holding paddles 272 than shown. For example, the shelf 250 can include the holding arm(s) 260, but not the holding paddle(s) 272. As another example, the shelf 250 can include the holding paddle(s) 272, but not the holding arm(s) 260. In at least one example, the holding paddle(s) 272 and the holding arm(s) 260 can be mechanically linked to move together. Optionally, the shelf 250 may not include either of the holding arms or the holding paddles. Optionally, the shelf 250 may not include the holding paddles 272.

The mounting frame 220 can also include a cover shroud 280 at a lower end 282. The cover shroud 280 can be formed of a resilient material, such as rubber and/or plastic. A bumper 284 (which can include one or more resilient stops 286, such as can be formed of rubber) can also be secured to the mounting frame 220 between the cover shroud 280 and the shelf 250. The cover shroud 280 and the bumper 284 are configured to provide cushioning resistance against a portion of a galley cart. Optionally, the mounting frame 220 may not include the cover shroud 280 and/or the bumper 284.

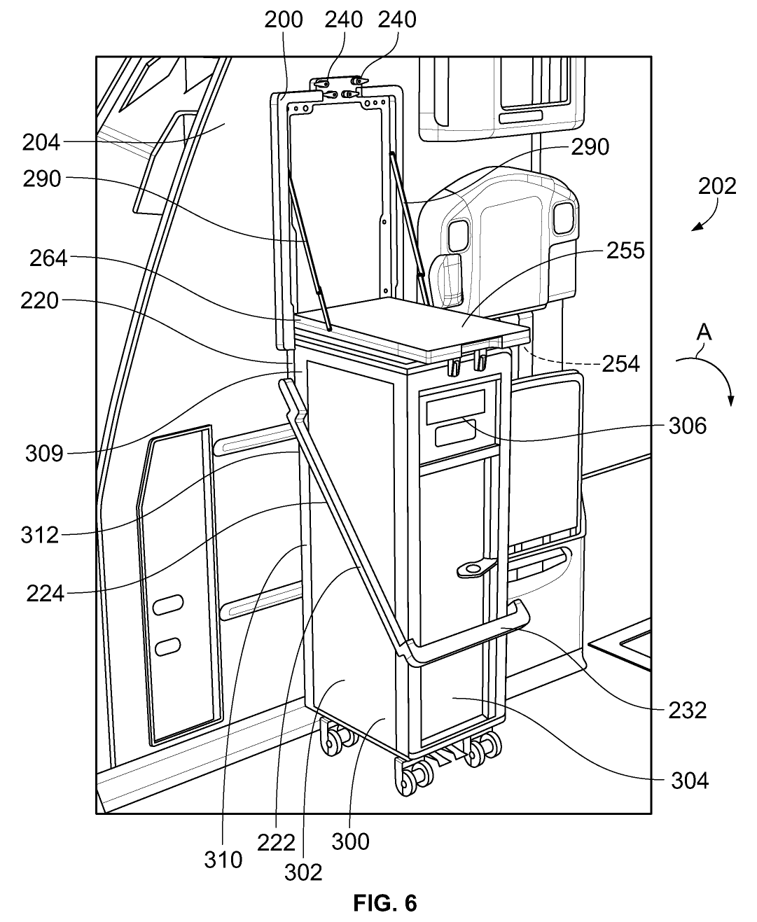

FIG. 6 illustrates a perspective view of the system 200 restraining a galley cart 300 within the internal cabin, according to an example of the present disclosure. The galley cart 300 includes a housing 302 having chambers configured to retain food items, beverages, trash, and/or the like. As an example, the galley cart 300 can be a trash cart dedicated to retaining trash. The housing 302 includes one or more doors 304, drawers 306, and/or the like configured to be opened and closed to selectively expose and close the chambers. The housing 302 is supported on rollers (such as wheels and/or casters) that allow the galley cart 300 to be easily moved within the internal cabin 202. As shown the galley cart 300 is a half-sized galley cart. Optionally, the galley cart 300 can be a full sized galley cart.

Referring to FIGS. 4-6, in order to securely restrain the galley cart 300, a top portion 309 of a rear end 310 of the galley cart 300 is moved against a lower portion of the mounting frame 220. For example, the top portion 309 of the rear end 310 abuts against the cover shroud 280 and/or the bumper 284, which cushion impact and protect the galley cart 300 from being scuffed, scratched, or the like. The system 200 is secured to the wall 204 so that the second end 264 of the shelf 250 is spaced apart from, and above a top surface 312 of the galley cart 300. After the galley cart 300 is moved against the mounting frame 220, the restraining clips 240 are pivoted from restraining positions to release positions. As such, the cross bar 232 of the cart restrainer 222 can be grasped, and the cart restrainer 222 can be pivoted downwardly and in front of the galley cart 300 in the direction of arc A. In this manner, the galley cart 300 is restrained between the first arm 224, the second arm 228, the cross bar 232, and the wall 204. The first arm 224 and the second arm 228 can be sized to accommodate half size galley carts and full size galley carts. If restraining a full size galley cart, the cross bar 232 is at a higher position when the cart restrainer is in the deployed position than shown in FIG. 6 (in which a half size galley cart is being restrained).

As noted, the shelf 250 need not be moved from a stowed position into a deployed position when the cart restrainer 222 is the deployed position. However, the shelf 250 can be moved from the stowed position to the deployed position over a top surface 312 of the galley cart 300. When the shelf 250 is in the deployed position, a surface 255 opposite from the surface 254 provides a support surface on which various objects (such as beverages, food items, cellular phones, or the like) can be supported. The system 200 can also include lateral support arms 290 (such as sliding and/or folding arms that connect to the mounting frame 220 and sides of the shelf 250) to secure the shelf 250 in a level position when the shelf 250 is in the deployed position.

The cart holding arms 260 and/or the cart holding paddles 272 can be moved into deployed positions to further restrain the top of the galley cart 300 therebetween. Optionally, the cart holding arms 260 and the cart holding paddles 272 may not be used.

In at least one example, the shelf 250 can be in the deployed position when the cart restrainer 222 is in the stowed position. The shelf 250 can be deployed even if the system 200 is not being used to restrain a galley cart.

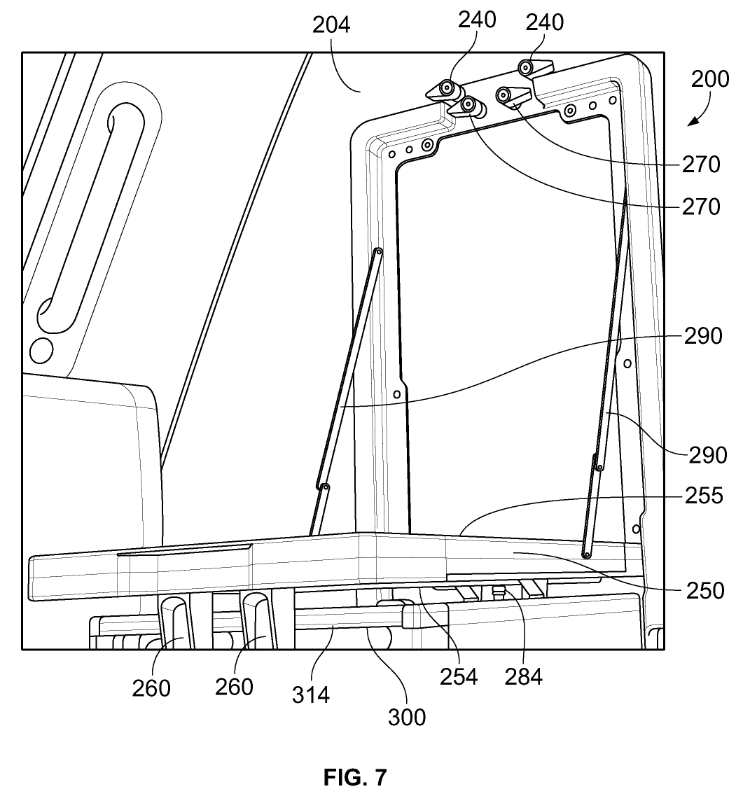

FIG. 7 illustrates a perspective front view of the system 200 having the shelf 250 in a deployed position, according to an example of the present disclosure. As shown in FIG. 7, the restraining clips 240 and 270 are in release positions. The cart holding arms 260 are in deployed positions, which provides a barrier past which the top, front portion 314 of the galley cart 300 is blocked from movement.

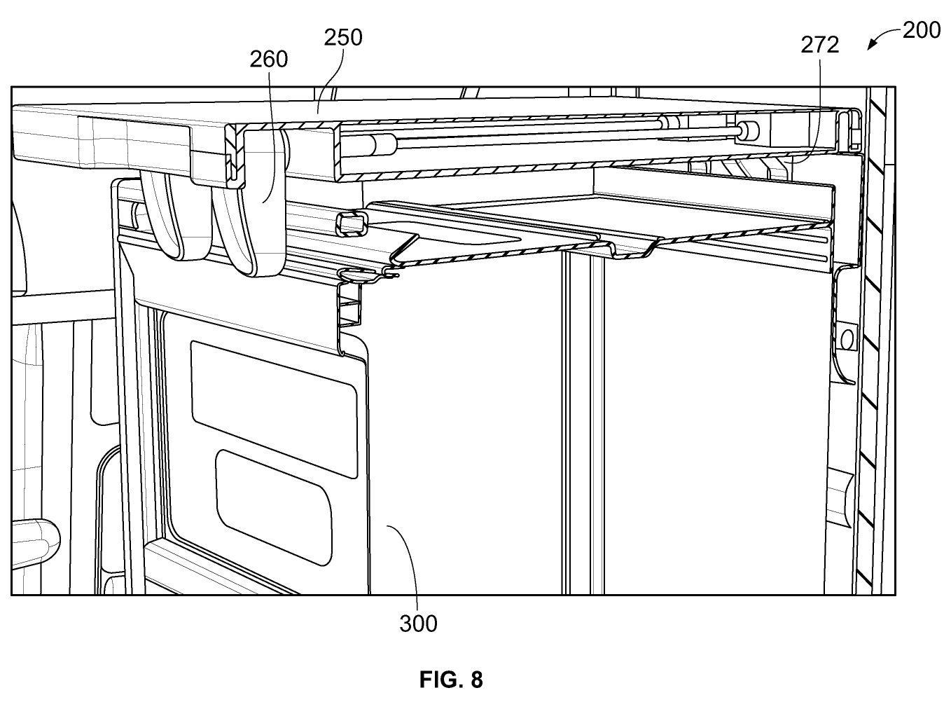

FIG. 8 illustrates a perspective side view of the shelf 250 in the deployed position, according to an example of the present disclosure. As shown, the top of the galley cart 300 is restrained from motion between the cart holding arms 260 in deployed positions, and the cart holding paddles 272 in deployed positions.

Referring to FIGS. 1-8, the system 200 is configured for restraining the galley cart 300 (such as a trash cart) within the internal cabin 202 of a vehicle, such as the aircraft 100. The system 200 includes the mounting frame 220 configured to be secured to the wall 204 within the internal cabin 202. The cart restrainer 222 is moveably coupled to the mounting frame 220. For example, the cart restrainer 222 is pivotally coupled to the mounting frame 220. As another example, the cart restrainer 222 is telescopically coupled to the mounting frame 220. As another example, the cart restrainer 222 is foldably coupled to the mounting frame 220. As another example, the cart restrainer 222 is slidably coupled to the mounting frame 220. As another example, the cart restrainer 222 is elastically coupled to the mounting frame 220 (for example, the cart restrainer 222 can be a resilient rubber strap). The cart restrainer 222 is configured to be moved between a first stowed position against the wall 204 and/or the mounting frame 220, and a first deployed position that is configured to restrain the galley cart 300 against the wall 204 and/or the mounting frame 220.

In at least one example, the system 200 also includes the shelf 250 moveably coupled to the mounting frame 220. The shelf 250 is configured to be moved between a second stowed position against the wall 204 and/or the mounting frame 220, and a second deployed position that is configured to allow items (such as beverages, food items, trays, plates, cellular phones, etc.) to be supported on the shelf 250. In at least one example, the cart restrainer 222 and the shelf 250 are independently moveable. Alternatively, the cart restrainer 222 and the shelf 250 move between the different positions along with one another.

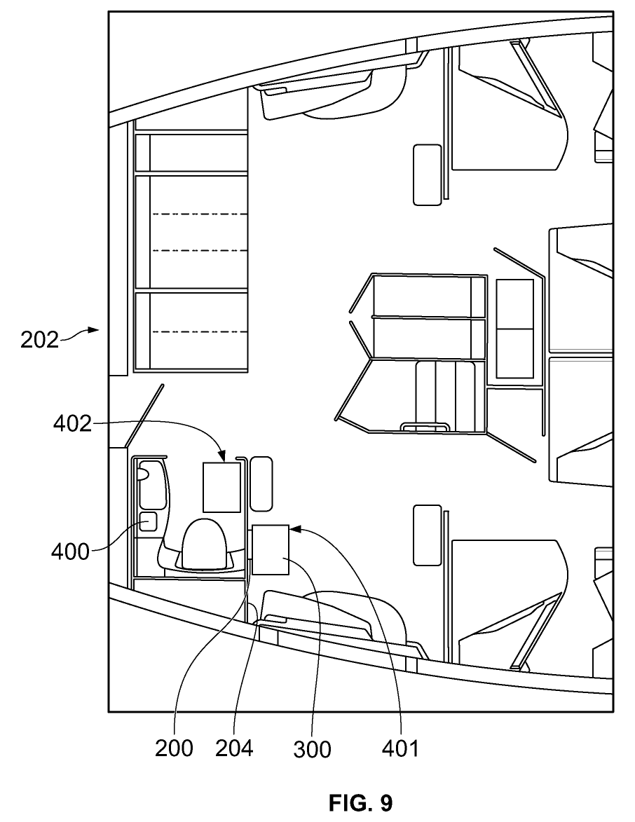

FIG. 9 illustrates a top plan view of a portion of the internal cabin 202, according to an example of the present disclosure. As shown, the system 200 is secured to the wall 204 of a monument, which can be a lavatory 400. During a cruise phase, for example, of a flight, the system 200 can be used to restrain the galley cart 300 in position 401. During certain phases of flight, such as take-off and/or landing, the galley cart 300 may be contained within other areas of the internal cabin 202, such as at position 402 within the lavatory 400. The lavatory 400 can include various restraining devices, such as latches, straps, clips, a docking station, and/or the like configured to secure the galley cart 300 at the position 402.

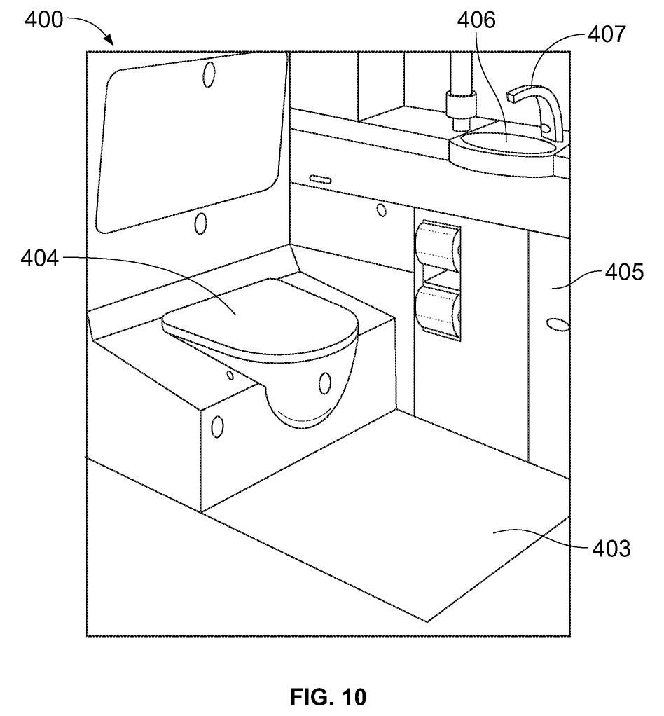

FIG. 10 illustrates an isometric internal view of a lavatory 400, according to an example of the present disclosure. The lavatory 400 includes a base floor 403 that supports a toilet 404, one or more cabinets 405, a sink 406 or wash basin, and a faucet 407. The lavatory 400 may be arranged differently than shown. The lavatory 400 may include more or less components than shown. Referring to FIGS. 9 and 10, the lavatory 400 can include one or more restraining devices configured to secure the galley cart 300 at the position 402.

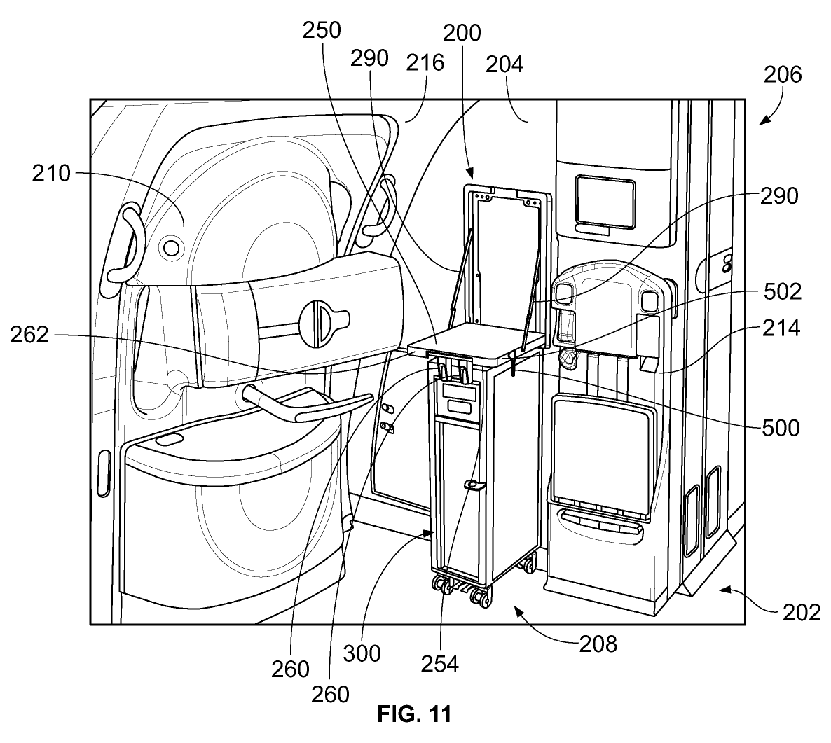

FIG. 11 illustrates a perspective view of a system 200 restraining a galley cart 300 within an internal cabin 202 of an aircraft, according to an example of the present disclosure. The system 200 is secured to a wall 204 of a monument 206, such as a galley. As another example, the monument 206 is a lavatory. As another example, the monument 206 is a closet.

In at least one example, the wall 204 faces a cross-aisle 208, which can be an egress path that leads to an exit door 210 within the internal cabin 202. The cross-aisle 208 intersects an aisle, which can be parallel to a longitudinal plane (such as the central longitudinal plane 150 shown in FIG. 2) of the internal cabin 202. The system 200 can be outboard from the aisle 212. Optionally, the system 200 can be inboard from the aisle 212 (such as if the system 200 is between two aisles).

As shown, the system 200 is mounted to the wall 204, which also supports a flight attendant seat 214. That is, the flight attendant seat 214 is also secured to the wall 204 and/or a floor. The system 200 is disposed between an outer wall 216 and the flight attendant seat 214. The system 200 is outboard from the flight attendant seat 214. Optionally, the system 200 can be secured to other walls, which may not also support a flight attendant seat. As another example, the system 200 can be inboard from the flight attendant seat 214.

As shown in FIG. 11, the system 200 is shown in a deployed position. The system 200 is similar to the similar system shown in FIGS. 3-8. However, the system 200 shown in FIG. 11 does not include the cart restrainer 222 (shown in FIGS. 4-6, for example). Instead, the system 200 includes the shelf 250, which includes one or more cart holding arms 260 pivotally coupled to the surface 254 proximate to the first end 262. As such, the cart holding arms 260 are front cart holding arms.

Additionally, the shelf 250 includes one or more cart holding arms 500 pivotally coupled the surface 254 and/or lateral surfaces 502 of the shelf 250. In this manner, the cart holding arms 500 are lateral cart holding arms or side braces. For example, the shelf 250 can include a first lateral cart holding arm on a first side, and a second lateral cart holding arm on a second side, which is opposite from the first side.

Each of the cart holding arm(s) 260 and the cart holding arms 500 are movable between a stowed position, and a deployed position (as shown in FIG. 11). The cart holding arms 260 can be quarter turn arms, for example. When the cart holding arms 260 and the cart holding arms 500 are in the deployed positions and the galley cart 300 is underneath the shelf 250, the system 200 restrains the galley cart 300 between a lower surface of the shelf 250, the cart holding arms 260, the cart holding arms 500, and the deployed holding paddles 272 (shown in FIGS. 4 and 5) (and/or the wall 204). Optionally, the system 200 may not include the holding paddles 272, and the wall 204 can be used as a restraining barrier. As such, the system 200 is configured to restrain the galley cart 300 without the need for a separate and distinct cart restrainer (such as the cart restrainer 222 shown in FIGS. 4-6, for example). Alternatively, the system 200 shown in FIG. 11 can also include the cart restrainer 222, as shown and described above.

FIG. 12 illustrates a perspective view of a system 200 for restraining a galley cart within an internal cabin 202 of an aircraft, according to an example of the present disclosure. The system 200 is secured to a wall 204 of a monument 206, such as a galley. As another example, the monument 206 is a lavatory. As another example, the monument 206 is a closet.

The wall 204 faces a cross-aisle 208, which can be an egress path that leads to an exit door 210 within the internal cabin 202. The cross-aisle 208 intersects an aisle, which can be parallel to a longitudinal plane (such as the central longitudinal plane 150 shown in FIG. 2) of the internal cabin 202. The system 200 can be outboard from the aisle 212. Optionally, the system 200 can be inboard from the aisle 212 (such as if the system 200 is between two aisles).

As shown, the system 200 is mounted to the wall 204, which also supports a flight attendant seat 214. That is, the flight attendant seat 214 is also secured to the wall 204 and/or a floor. The system 200 is disposed between an outer wall 216 and the flight attendant seat 214. The system 200 is outboard from the flight attendant seat 214. Optionally, the system 200 can be secured to other walls, which may not also support a flight attendant seat. As another example, the system 200 can be inboard from the flight attendant seat 214.

As shown in FIG. 12, the system 200 is shown in a stowed position. In the stowed position, the system 200 can be recessed into the wall 204. For example, the wall 204 can include a recessed channel that retains the system 200.

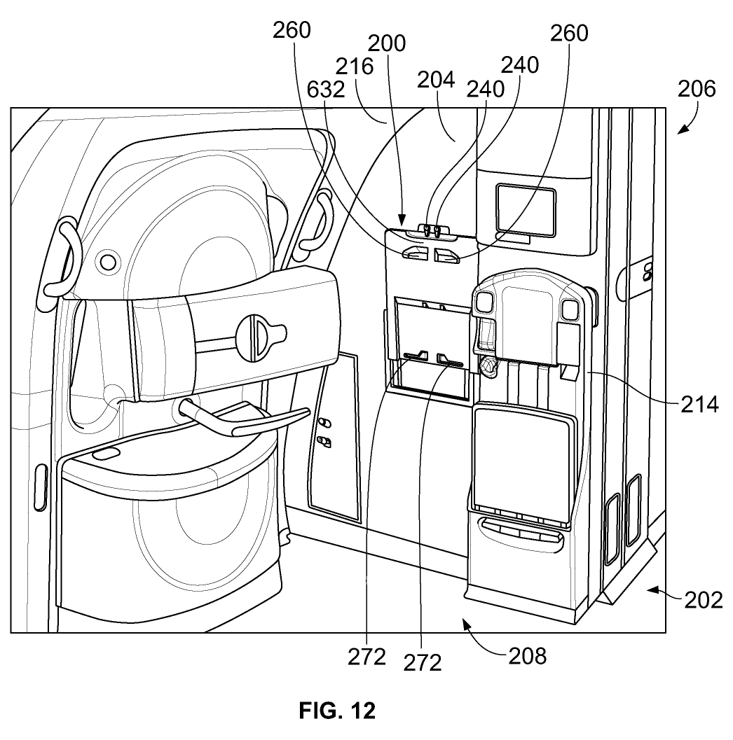

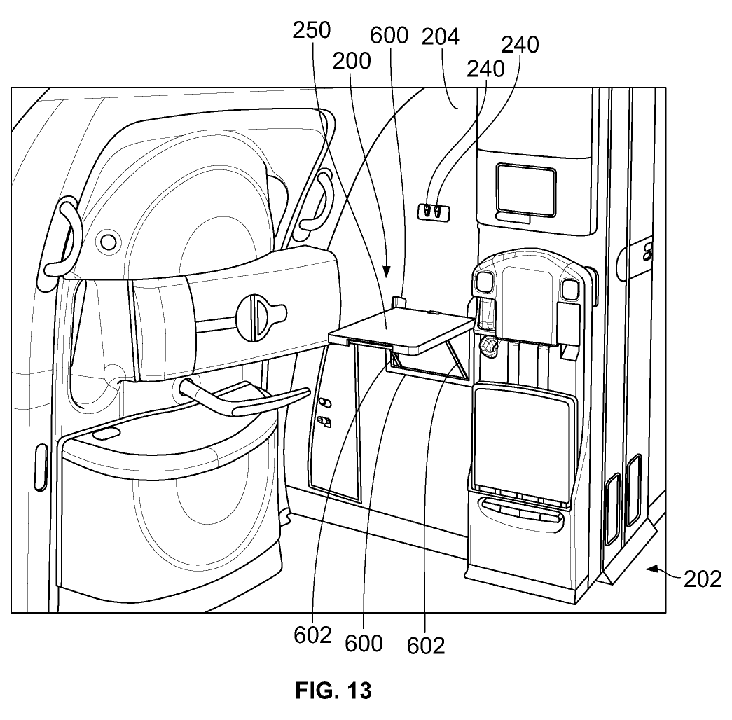

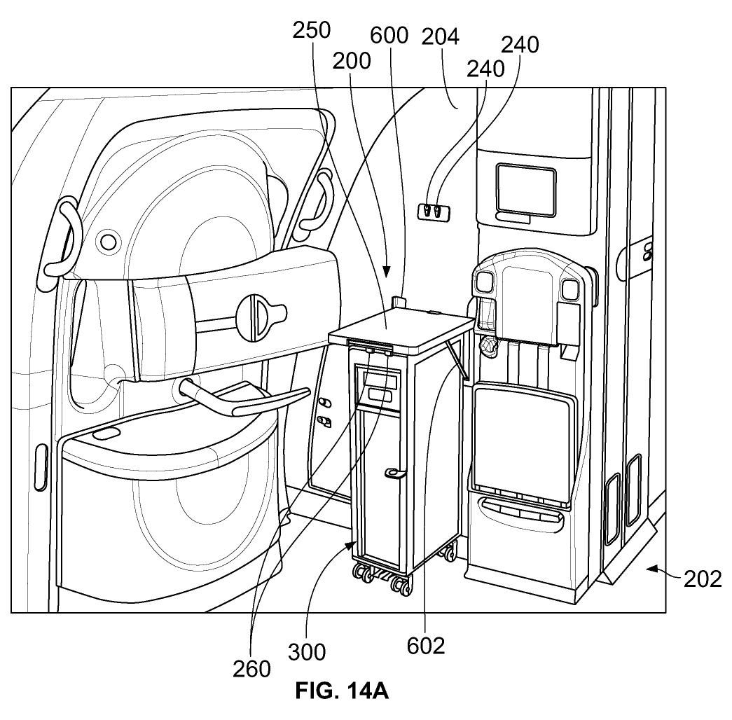

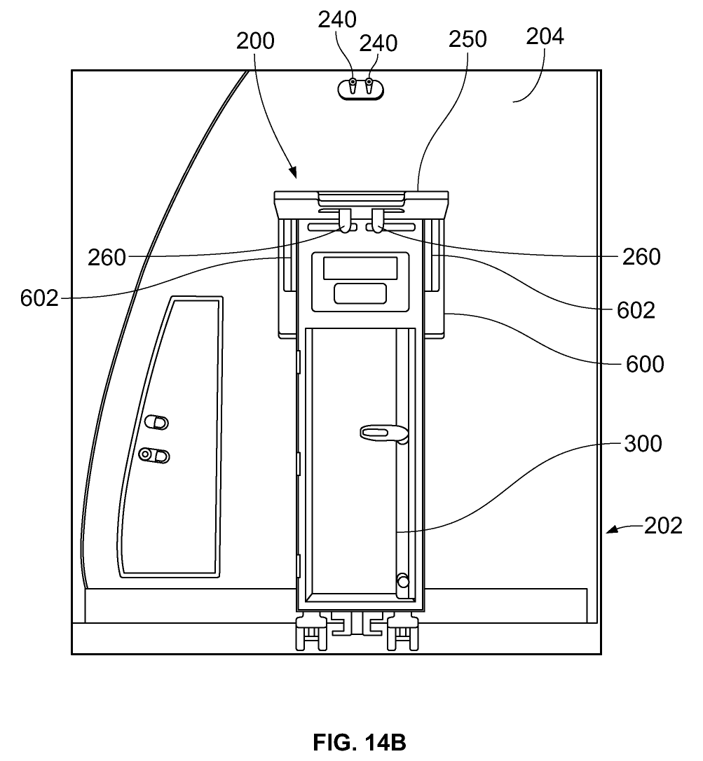

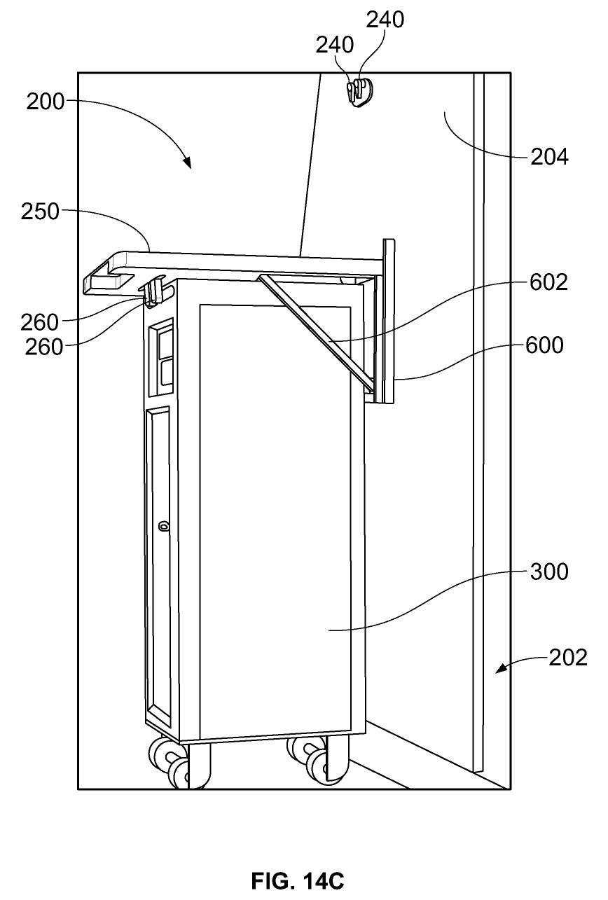

FIG. 13 illustrates a perspective view of the system 200 of FIG. 12 in a deployed position, according to an example of the present disclosure. FIG. 14A illustrates a perspective view of the system 200 of FIGS. 12 and 13 restraining a galley cart 300 within the internal cabin 202 of the aircraft. FIG. 14B illustrates a front view of the system 200 of FIGS. 12 and 13 restraining the galley cart 300 within the internal cabin 202 of the aircraft. FIG. 14C illustrates a perspective side of the system 200 of FIGS. 12 and 13 restraining the galley cart 300 within the internal cabin 202 of the aircraft. Referring to FIGS. 12-14C, the system 200 includes a shelf 250 pivotally coupled to a mounting frame 600. The system 200 is similar to the system 200 shown and described with respect to FIG. 11, except that the system 200 may not include the cart holding arms 500. Further, the mounting frame 600 is mounted to the wall 204, and extends below the shelf 250 in the deployed position. Additionally, the restraining clips 240 can be directly mounted to the wall 204 (instead of being secured to an upper portion of a frame). Alternatively, the system 200 shown in FIGS. 12-14 may optionally include the cart holding arms 500 shown in FIG. 11.

The shelf 250 also includes the cart holding arms 260 and the holding paddles 272. The system 200 also includes lateral support arms 602 (such as sliding and/or folding arms that connect to the mounting frame 600 and sides of the shelf 250) to secure the shelf 250 in a level position when the shelf 250 is in the deployed position, as shown in FIGS. 13 and 14. Because the mounting frame 600 extends below the shelf 250 in the deployed position, the lateral support arms 602 in extended support positions (as shown in FIG. 13) provide lateral braces that laterally restrain a galley cart when positioned below the shelf 250. In particular, the lateral support arms 602 are inverted compared to the lateral support arms 290 shown in FIGS. 6 and 7, for example. The lateral support arms 602 in the extended support positions restrain sides of the galley cart 300, and are configured to restrain side loads exerted by the galley cart 300. As such, the system 200 shown in FIGS. 12-14 is configured to restrain the galley cart 300 without the need for a separate and distinct cart restrainer (such as the cart restrainer 222 shown in FIGS. 4-6, for example) or lateral cart holding arms (such as the cart holding arms 500 shown in FIG. 11). Alternatively, the system 200 shown in FIGS. 12-14 can also include the cart restrainer 222, as shown and described above.

When the cart holding arms 260 and the lateral support arms 602 are in the extended support positions to support the shelf 250 in a level position (as shown in FIG. 13), and the galley cart is underneath the shelf 250, the system 200 restrains the galley cart between a lower surface of the shelf 250, the cart holding arms 260, the lateral support arms 602 in the extended support position, and the deployed holding paddles 272 (and/or the wall 204). Optionally, the system 200 may not include the holding paddles 272, and the wall 204 can be used as a restraining barrier.

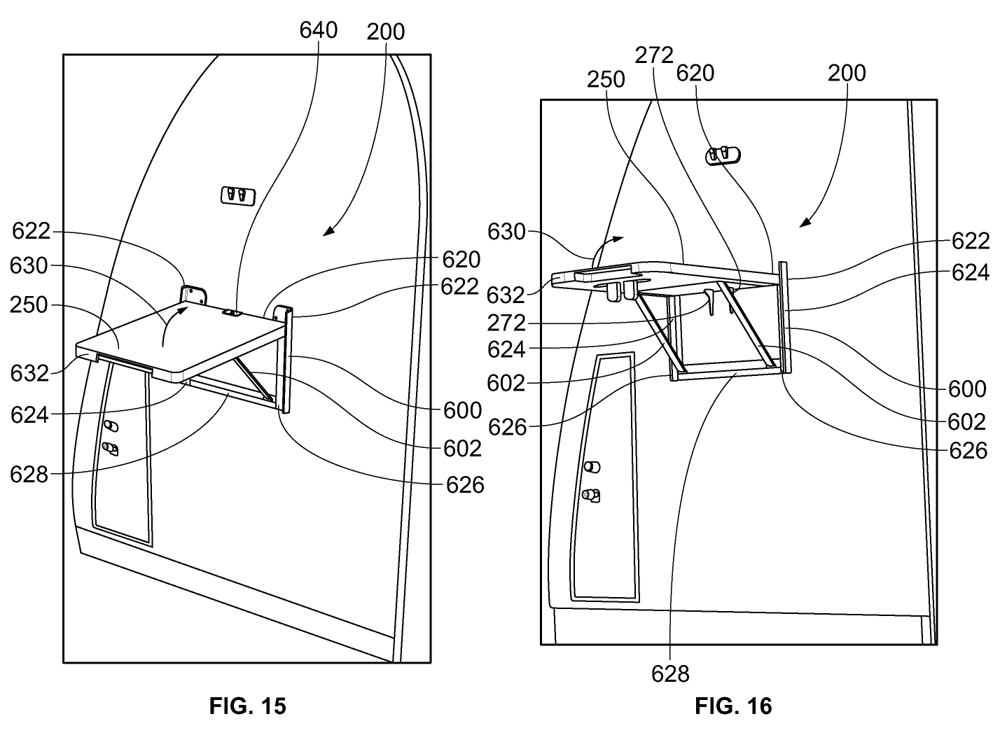

FIG. 15 illustrates a perspective top view of the system 200 of FIGS. 12-14 in the deployed position. FIG. 16 illustrates a perspective bottom view of the system 200 of FIGS. 12-15 in the deployed position. Referring to FIGS. 15 and 16, a rear (second) end 620 of the shelf 250 is pivotally coupled to upper portions 622 of lateral uprights 624 of the mounting frame 600. Lower ends 626 of the lateral uprights 624 can be connected by a bottom cross beam 628. The shelf 250 is configured to pivot upwardly from the deployed position (shown in FIGS. 13-16) about the pivotal connections at the upper portions 622 toward and into the stowed position (shown in FIG. 12) in the direction of arc 630. The restraining clips 240 are used to engage the front (first) end 632 of the shelf 250 and restrain the shelf 250 in the stowed position.

In at least one example, the shelf 250 further includes a release latch 640. For example, the release latch 640 can be disposed at a central portion of the rear end 620 of the shelf 250.

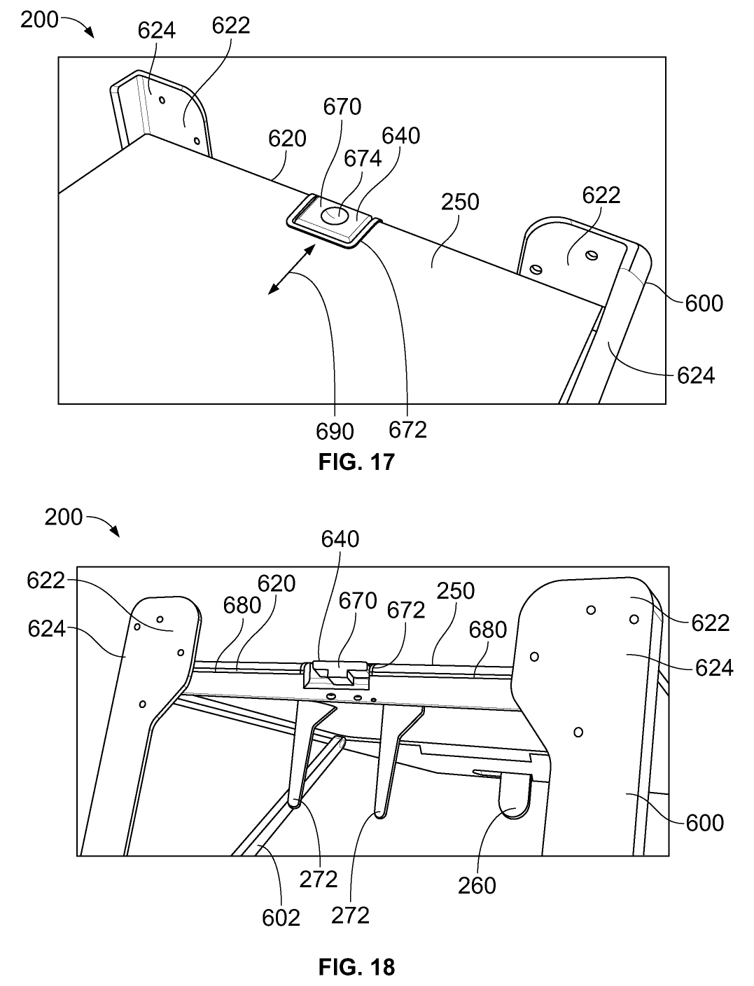

FIG. 17 illustrates a front, top perspective view of the rear end 620 of the shelf 250 of the system 200 of FIGS. 12-16 in the deployed position. FIG. 18 illustrates a rear, bottom perspective view of the rear end 620 of the shelf 250 of the system 200 of FIGS. 12-17 in the deployed position. The release latch 640 includes a button 670 moveably retained within a reciprocal opening 672 formed in the rear end 620 of the shelf 250. The button 670 can include an indentation 674, which is ergonomically sized and shaped to receive a finger of an individual, for example.

The button 670 is operatively coupled to bracing rods 680. In at rest-positions, the bracing rods 680 extend into reciprocal openings formed in the lateral uprights 624 of the mounting frame 600. In this manner, the bracing rods 680 assist in supporting the shelf 250 in the deployed position.

In order to pivot the shelf 250 upwardly, the release latch 640 is engaged, such as by pulling the button 670 of the release latch 640 in either of the directions 690. Because the bracing rods 680 are operatively coupled to the button 670, the movement of the button 670 thereby disengages the bracing rods 680 from the mounting frame 600, and thereby allows the shelf 250 to be easily pivoted upward toward and into the stowed position (shown in FIG. 12). Alternatively, the system 200 may not include the release latch 640 and bracing rods 680.

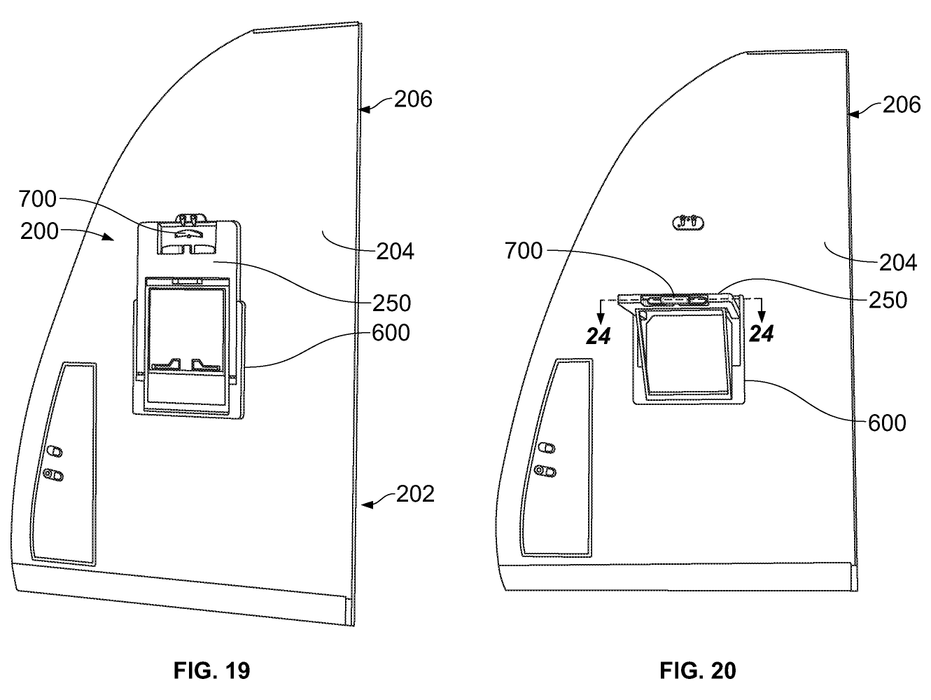

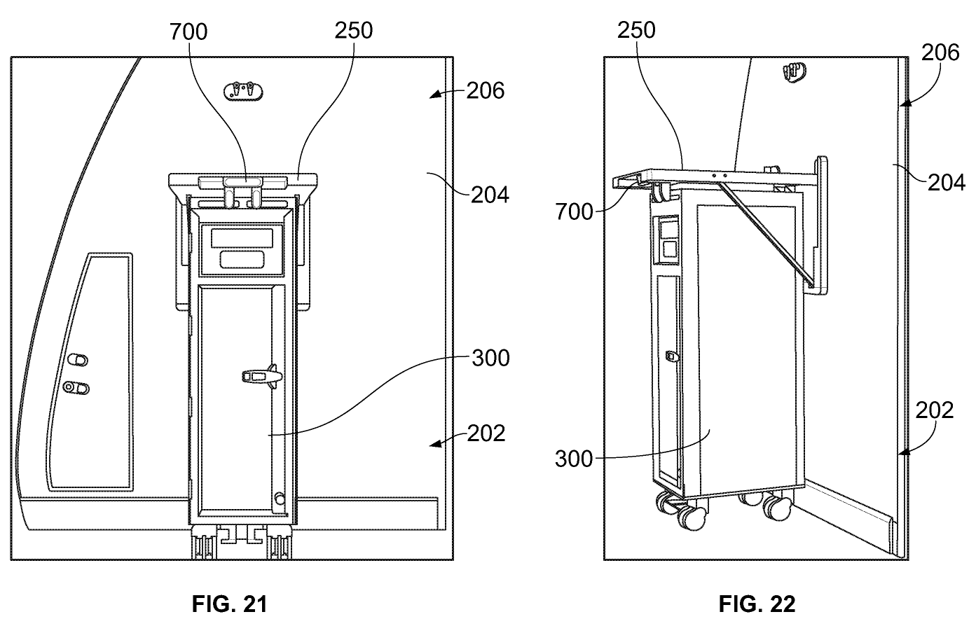

FIG. 19 illustrates a perspective front view of a system 200 in a stowed position, according to an example of the present disclosure. FIG. 20 illustrates a perspective front view of the system 200 of FIG. 19 in a deployed position. FIG. 21 illustrates a front view of the system of FIGS. 19 and 20 restraining a galley cart 300 within an internal cabin 202 of an aircraft. FIG. 22 illustrates a side perspective view of the system 200 of FIGS. 19-21 restraining the galley cart 300 within the internal cabin 202 of the aircraft. Referring to FIGS. 19-22, the system 200 is secured to a wall 204 of a monument 206, such as a galley. As another example, the monument 206 is a lavatory. As another example, the monument 206 is a closet.

In the stowed position, the system 200 can be recessed into the wall 204. For example, the wall 204 can include a recessed channel that retains the system 200. As another example, the system 200 can be secured to an outer surface of the wall 204.

The system 200 includes a shelf 250 pivotally coupled to a mounting frame 600. The system 200 is similar to the system 200 shown and described with respect to FIGS. 12-18. The system 200 shown and described with respect to FIGS. 19-27 includes a release handle 700, which can also be used with any of the examples of the system 200 shown and described with respect to FIGS. 1-18. In particular, the shelf 250 having the release handle 700 can be used with any of the examples shown in FIGS. 1-18. As described herein, the release handle 700 is configured to be engaged by an individual to allow the shelf 250 to be unlocked from the deployed position, so that the shelf 250 can be moved back to the stowed position.

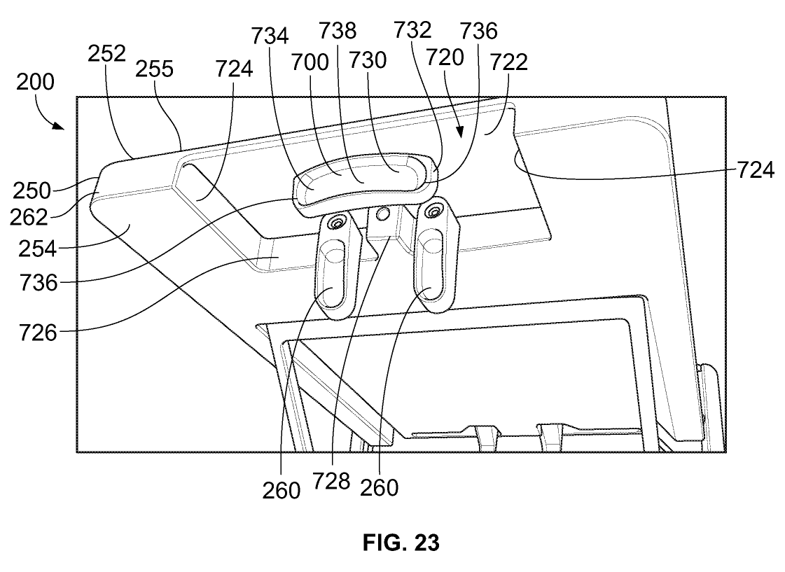

FIG. 23 illustrates a bottom perspective view of the shelf 250 of the system 200 of FIGS. 19-22. The shelf 250 includes the planar main body 252 having the surface 254. In the stowed position, the surface 254 is a front surface. In the deployed position, the surface 254 is a bottom surface. The surface 254 is opposite from the surface 255 (such as a top surface, as shown in FIG. 23).

The shelf 250 includes a recessed area 720 defined between an upper recessed wall 722 of a central front portion of the surface 254, lateral walls 724 formed in the surface 254, and a rear wall 726 of the surface 254. A central block 728 forwardly extends from the rear wall 726. The cart holding arms 260 are pivotally coupled to the surface 254. In particular, the cart holding arms 260 are pivotally coupled to the rear wall 726. The central block 728 is disposed between the cart holding arms 260 and provides a barrier past which the cart holding arms 260 are prevented from further pivotal motion. Optionally, the recessed area 720 may not include the central block 728. The cart holding arms 260 are movable between a stowed position, and a deployed position. The cart holding arms 260 can be quarter turn arms, for example.

The release handle 700 is disposed within the recessed area 720 below the upper recessed wall 722. The release handle 700 is moveably secured within the recessed area 720. In particular, the release handle 700 is configured to be grasped and pulled within the recessed area 720, as described herein. The release handle 700 is exposed within the recessed area 720 within the first end 262 of the shelf 250. The release handle 700 is configured to be grasped within the recessed area 720.

The release handle 700 includes a grasp bar 730 including a leading cross beam 732 having an bowed indented channel 734 formed therein. The bowed indented channel 734 can be downwardly bowed. For example, ends 736 are below a central portion 738. Further, the bowed indented channel 734 includes smooth, blunted surfaces which are ergonomically easy and comfortable to grasp. The bowed indented channel 734 provides an ergonomic shape that is configured to be easily grasped, such as by fingers (such as a thumb) of an individual. An opposite side of the grasp bar 730 can also include a bowed indented channel. Optionally, the indented channel 734 may not be bowed. Instead, the indented channel 734 can have a central longitudinal axis that is linear. Also, optionally, the indented channel may not include arcuate surfaces, but can instead be block shaped, for example. Alternatively, the grasp bar 730 may not include the curved indented channel.

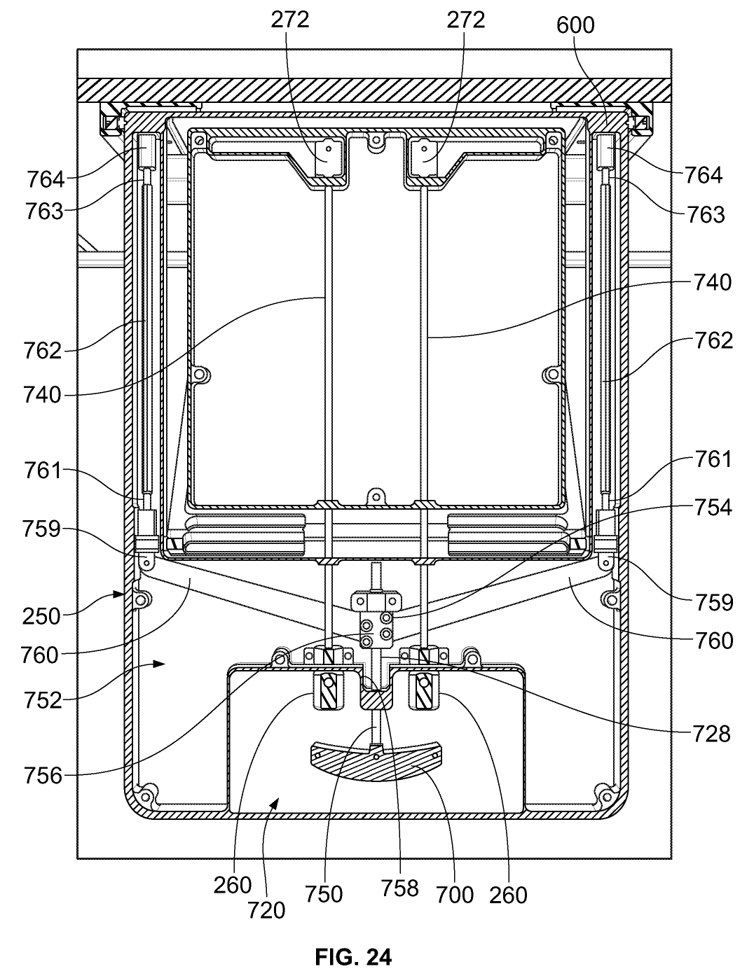

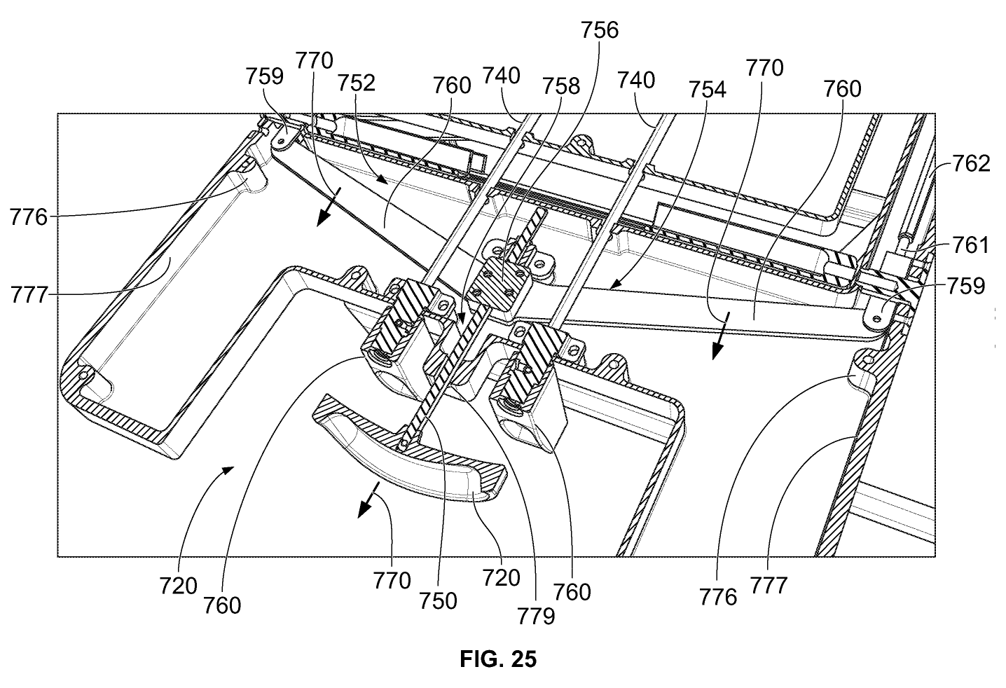

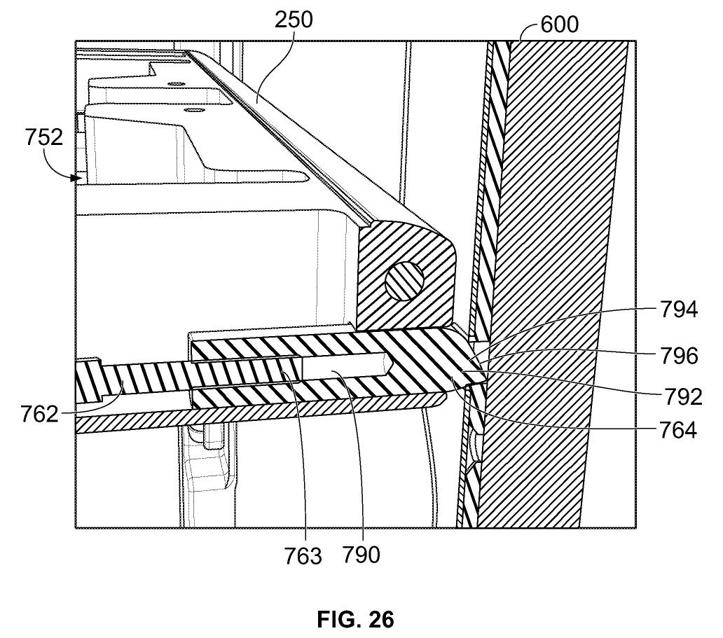

FIG. 24 illustrates a cross-sectional view of the shelf 250 of the system 200 through line 24-24 of FIG. 20. FIG. 25 illustrates a perspective cross-sectional view of a portion of the shelf 250 of the system 200 through line 24-24 of FIG. 20. Referring to FIGS. 24 and 25, the cart holding arms 260 are moveably coupled to the holding paddles 272 through one or more links. For example, each cart holding arm 260 is coupled to a holding paddle 272 through a link 740, such as a rod, within an internal chamber 752 of the shelf. The link 740 directly couples a cart holding arm 260 to a holding paddle 272. For example, the link 740 can extend into and through the cart holding arm 260 and the holding paddle 272, thereby coordinating pivotal motion of the cart holding arm 260 and the holding paddle 272. In this manner, movement of each holding paddle 272 is responsive to movement of a respective cart holding arm 260. In particular, the link 740 causes movement of the cart holding arm 260 to be translated to the holding paddle 272. As such, when the cart holding arm 260 is deployed, the holding paddle 272 is also deployed. Similarly, when the cart holding arm 260 is closed, the holding paddle 272 is also deployed. Optionally, an additional link can couple the cart holding arms 260 together, and/or an additional link can couple the holding paddles 272 together. As such, movement of one cart holding arm 260 causes a responsive pivotal motion in the other cart holding arm 260 and both holding paddles 272. Alternatively, the cart holding arms 260 may not be linked to the holding paddles 272.

The release handle 700 connects to (for example, extends from) a beam 750 which extends into the internal chamber 752 of the shelf 250. For example, the beam 750 extends into and through an opening 729 formed in the central block 728. The beam 750 connects to a coupling cross beam 754 within the central chamber 752. The coupling cross beam 754 includes a central bracket 756, which is sized and shaped to extend into an internal chamber 758 defined by the central block 728. Lateral arms 760 extend laterally and rearwardly away from the bracket 756 and connect to pivot brackets 759, which connect to (such as by pinned pivotal couplings) first ends 761 of rods 762. Each rod 762 includes an opposite second end 763 secured to a latch 764.

Referring to FIGS. 19-25, when the system 200 is in the deployed position (shown in FIG. 20), the latches 764 are coupled to the mounting frame 600 (such as by being retained within retaining recess formed therein), thereby securing the shelf 250 in the deployed position. In order to disengage the rods 762 from the latches 764 and allow the shelf 250 to be pivoted into the stowed position, the release handle 700 is pulled in the direction of arrow 770. As the release handle 700 is pulled in the direction of arrow 770, the beam 750 follows along therewith, which causes the coupling cross beam 754 to also move in the direction of arrows 770, thereby causing the rods 762 and the latches 764 to follow in the same direction, which causes the latches 764 to disengage from the mounting frame 600. When the latches 764 disengage from the mounting frame 600, the shelf 250 can be moved into the deployed position.

Optionally, the latches 764 can be used to secure (or at least assist in securing) the shelf 250 in the stowed position. For example, the latches 764 can be configured to be retained by portions of the mounting frame 600, thereby latching the shelf 250 in the stowed position.

In at least one example, the shelf 250 includes one or more stops that limit a range of motion of the release handle 700, and components moveably connected thereto. For example, movement of the release handle 700 is limited by movement of the bracket 756 into the internal chamber 758 of the central block 728. That is, internal surfaces of the central block 728 within the internal chamber 758 provide a stop past which the bracket 756 cannot pass, thereby limiting translational motion of the handle 700, the beam 750, the coupling cross beam 754, the rods 762, and the latches 764. Further, lateral stops 776 can extend into the internal chamber 752 from side walls 777 proximate to the pivot bracket 759, and also provide barriers past which the pivot brackets 759 cannot pass, thereby providing additional stops.

After the handle 700 is disengaged, the handle 700 and connected components (for example, the coupling cross beam 754 and the rods 762) recede back in directions opposite from the direction of arrows 770. For example, the handle 700, the coupling cross beam 754, and/or the rods 762 can be spring-biased, and configured to return to at-rest positions when a pulling force in the direction of arrows 770 is not applied to the handle 700. Optionally, the handle 700 may not be spring-biased, but can be actively pushed inward to return to the components back to previous positions.

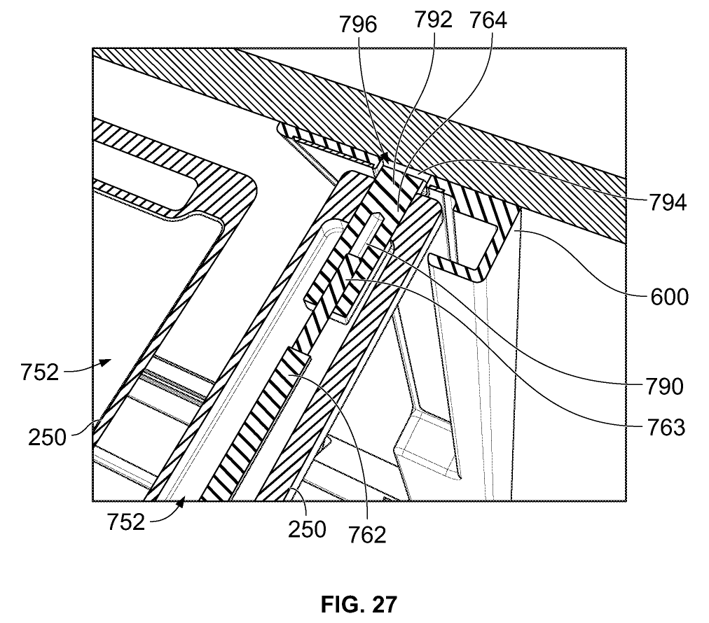

FIG. 26 illustrates a perspective internal lateral view of an end of the shelf 250 in the deployed position, according to an example of the present disclosure. FIG. 27 a perspective top view of the end of the shelf 250 in the deployed position. Referring to FIGS. 26 and 27, the ends 763 of the rods 762 are secured within reciprocal channels 790 formed in the latches 764. Optionally, the rods 762 can be integrally formed with the latches 764 without ends being disposed within reciprocal channels.

Each latch 764 includes a clasp 792 disposed away from the end 763. The clasp 792 has an edge 794 that is configured to be retained within a retaining recess 796 formed in the frame 600. As such, when the shelf 250 is in the deployed position, the clasp 792 securely latches onto the frame 600, such as by the edge 794 of the clasp 792 being retained within the retaining recess 796. In this manner, the latches 764 are configured to retain (or at least assist in retaining) the shelf 250 in the deployed position. As such, the shelf 250 can be passively locked into the deployed position. Referring to FIGS. 19-27, in order to release the latches 764, the release handle 700 is pulled in the direction of arrow 770, which disengages the latches 764 from the channel 790, and the shelf 250 can then be pivoted upwardly into the stowed position.

Further, the disclosure includes examples according to the following clauses:
Clause 1. A system for restraining a galley cart within an internal cabin of a vehicle, the system comprising: a mounting frame configured to be secured to a wall within the internal cabin; a shelf pivotally coupled to the mounting frame, wherein the shelf is configured to be moved between a first stowed position against one or both of the wall or the mounting frame, and a first deployed position that is configured to allow items to be supported on the shelf, wherein the shelf comprises a release handle configured to be engaged to unlock the shelf from the first deployed position.
Clause 2. The system of Clause 1, wherein the shelf further comprises a recessed area, wherein the release handle is moveably secured within the recessed area.
Clause 3. The system of Clause 2, wherein the recessed area is defined between an upper recessed wall of a central front portion of the shelf, lateral walls formed in the shelf, and a rear wall formed in the shelf.
Clause 4. The system of Clause 3, wherein the shelf further comprises a central block forwardly extending from the rear wall.
Clause 5. The system of Clause 4, wherein the shelf further comprises cart holding arms pivotally coupled to the rear wall, wherein the central block is disposed between the cart holding arms, and wherein the cart holding arms are moveable between a second stowed position and a second deployed position,.
Clause 6. The system of clause 5, wherein the shelf further comprises holding paddles moveably coupled to the cart holding arms through one or more links, wherein the holding paddles are moveable between a third stowed position and a third deployed position, wherein a top portion of the galley cart is configured to be restrained between the cart holding arms in the second deployed position and the holding paddles in the third deployed position when the shelf is in the first deployed position.
Clause 7. The system of Clause 6, wherein the one or more links comprise one or more rods, wherein each of the cart holding arms is coupled to a respective one of the cart holding arms by the one or more rods.
Clause 8. The system of any of Clauses 1-7, wherein the release handle comprises a grasp bar having a bowed indented channel.
Clause 9. The system of any of Clauses 1-8, wherein the release handle connects to a beam which extends into an internal chamber of the shelf, wherein the beam connects to a coupling cross beam within the central chamber, and wherein the coupling cross beam connects to rods connected to latches.
Clause 10. The system of Clause 9, wherein the beam extends into and through an opening formed in a central block within a recessed area of the shelf.
Clause 11. The system of Clauses 9 or 10, wherein the coupling cross beam includes a central bracket, wherein lateral arms extend from the bracket and connect to pivot brackets, and wherein the pivot brackets connect to the rods.
Clause 12. The system of any of Clauses 9-11, wherein the mounting frame comprises retaining recesses which retain one or more portions of the latches when the shelf is in the first deployed position.
Clause 13. The system of any of Clauses 1-12, wherein the shelf further comprises one or more stops configured to limit a range of motion of the release handle.
Clause 14. A vehicle comprising: an internal cabin; a monument within the internal cabin, wherein the monument comprises a wall, and wherein the wall faces a cross-aisle within the internal cabin; and a system for restraining a galley cart within the internal cabin of a vehicle, the system comprising: a mounting frame secured to the wall within the internal cabin; a shelf pivotally coupled to the mounting frame, wherein the shelf is configured to be moved between a first stowed position against one or both of the wall or the mounting frame, and a first deployed position that is configured to allow items to be supported on the shelf, wherein the shelf comprises a release handle configured to be engaged to unlock the shelf from the first deployed position.
Clause 15. The vehicle of Clause 14, wherein the shelf further comprises a recessed area, wherein the release handle is moveably secured within the recessed area, wherein the recessed area is defined between an upper recessed wall of a central front portion of the shelf, lateral walls formed in the shelf, a rear wall formed in the shelf, and a central block forwardly extending from the rear wall.
Clause 16. The vehicle of Clauses 14 or 15, wherein the shelf further comprises cart holding arms pivotally coupled to the rear wall, wherein the central block is disposed between the cart holding arms, and wherein the cart holding arms are moveable between a second stowed position and a second deployed position,.
Clause 17. The vehicle of Clause 16, wherein the shelf further comprises holding paddles moveably coupled to the cart holding arms through one or more links, wherein the holding paddles are moveable between a third stowed position and a third deployed position, wherein a top portion of the galley cart is configured to be restrained between the cart holding arms in the second deployed position and the holding paddles in the third deployed position when the shelf is in the first deployed position.
Clause 18. The vehicle of any of Clauses 14-17, wherein the release handle comprises: a grasp bar having a bowed indented channel; and one or more stops configured to limit a range of motion of the release handle.
Clause 19. The vehicle of any of Clauses 14-18, wherein the release handle connects to a beam which extends into an internal chamber of the shelf, wherein the beam connects to a coupling cross beam within the central chamber, and wherein the coupling cross beam connects to rods connected to latches, wherein the coupling cross beam includes a central bracket, wherein lateral arms extend from the bracket and connect to pivot brackets, and wherein the pivot brackets connect to the rods.
Clause 20. The vehicle of Clause 19, wherein the mounting frame comprises retaining recesses which retain one or more portions of the latches when the shelf is in the first deployed position.

As described herein, examples of the present disclosure provide systems and methods for securing a galley cart in a convenient position within an internal cabin of an aircraft. Further, examples of the present disclosure provide systems and methods for securing a galley cart at a location other than a dedicated compartment within a galley.

While various spatial and directional terms, such as top, bottom, lower, mid, lateral, horizontal, vertical, front and the like can be used to describe embodiments of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) can be used in combination with each other. In addition, many modifications can be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims and the detailed description herein, the terms "including" and "in which" are used as the plain-English equivalents of the respective terms "comprising" and "wherein." Moreover, the terms "first," "second," and "third," etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A system for restraining a galley cart within an internal cabin of a vehicle, the system comprising:
a mounting frame configured to be secured to a wall within the internal cabin;
a shelf pivotally coupled to the mounting frame, wherein the shelf is configured to be moved between a first stowed position against one or both of the wall or the mounting frame, and a first deployed position that is configured to allow items to be supported on the shelf,
wherein the shelf comprises a release handle configured to be engaged to unlock the shelf from the first deployed position.

2. The system of claim 1, wherein the shelf further comprises a recessed area, wherein the release handle is moveably secured within the recessed area.

3. The system of claim 2, wherein the recessed area is defined between an upper recessed wall of a central front portion of the shelf, lateral walls formed in the shelf, and a rear wall formed in the shelf.

4. The system of claim 3, wherein the shelf further comprises a central block forwardly extending from the rear wall.

5. The system of claim 4, wherein the shelf further comprises cart holding arms pivotally coupled to the rear wall, wherein the central block is disposed between the cart holding arms, and wherein the cart holding arms are moveable between a second stowed position and a second deployed position,.

6. The system of claim 5, wherein the shelf further comprises holding paddles moveably coupled to the cart holding arms through one or more links, wherein the holding paddles are moveable between a third stowed position and a third deployed position, wherein a top portion of the galley cart is configured to be restrained between the cart holding arms in the second deployed position and the holding paddles in the third deployed position when the shelf is in the first deployed position.

7. The system of claim 6, wherein the one or more links comprise one or more rods, wherein each of the cart holding arms is coupled to a respective one of the cart holding arms by the one or more rods.

8. The system of claim 1, wherein the release handle comprises a grasp bar having a bowed indented channel.

9. The system of claim 1, wherein the release handle connects to a beam which extends into an internal chamber of the shelf, wherein the beam connects to a coupling cross beam within the central chamber, and wherein the coupling cross beam connects to rods connected to latches.

10. The system of claim 9, wherein the beam extends into and through an opening formed in a central block within a recessed area of the shelf.

11. The system of claim 9, wherein the coupling cross beam includes a central bracket, wherein lateral arms extend from the bracket and connect to pivot brackets, and wherein the pivot brackets connect to the rods.

12. The system of claim 9, wherein the mounting frame comprises retaining recesses which retain one or more portions of the latches when the shelf is in the first deployed position.

13. The system of claim 1, wherein the shelf further comprises one or more stops configured to limit a range of motion of the release handle.

14. A vehicle comprising:
an internal cabin;
a monument within the internal cabin, wherein the monument comprises a wall, and wherein the wall faces a cross-aisle within the internal cabin; and
a system for restraining a galley cart within the internal cabin of a vehicle, the system comprising:
a mounting frame secured to the wall within the internal cabin;
a shelf pivotally coupled to the mounting frame, wherein the shelf is configured to be moved between a first stowed position against one or both of the wall or the mounting frame, and a first deployed position that is configured to allow items to be supported on the shelf,
wherein the shelf comprises a release handle configured to be engaged to unlock the shelf from the first deployed position.

15. The vehicle of claim 14, wherein the shelf further comprises a recessed area, wherein the release handle is moveably secured within the recessed area, wherein the recessed area is defined between an upper recessed wall of a central front portion of the shelf, lateral walls formed in the shelf, a rear wall formed in the shelf, and a central block forwardly extending from the rear wall.

16. The vehicle of claim 14, wherein the shelf further comprises cart holding arms pivotally coupled to the rear wall, wherein the central block is disposed between the cart holding arms, and wherein the cart holding arms are moveable between a second stowed position and a second deployed position,.

17. The vehicle of claim 16, wherein the shelf further comprises holding paddles moveably coupled to the cart holding arms through one or more links, wherein the holding paddles are moveable between a third stowed position and a third deployed position, wherein a top portion of the galley cart is configured to be restrained between the cart holding arms in the second deployed position and the holding paddles in the third deployed position when the shelf is in the first deployed position.

18. The vehicle of claim 14, wherein the release handle comprises:
a grasp bar having a bowed indented channel; and
one or more stops configured to limit a range of motion of the release handle.

19. The vehicle of claim 14, wherein the release handle connects to a beam which extends into an internal chamber of the shelf, wherein the beam connects to a coupling cross beam within the central chamber, and wherein the coupling cross beam connects to rods connected to latches, wherein the coupling cross beam includes a central bracket, wherein lateral arms extend from the bracket and connect to pivot brackets, and wherein the pivot brackets connect to the rods.

20. The vehicle of claim 19, wherein the mounting frame comprises retaining recesses which retain one or more portions of the latches when the shelf is in the first deployed position.
